(19) United States
(12) Patent Application Publication
(10) Pub. No.: US 2015/0332230 A1
(43) Pub. Date: Nov. 19, 2015

(54) SELECTION OF MERCHANT AND DEVICE SPECIFIC PAYMENT FLOW

(71) Applicant: EBAY INC., San Jose, CA (US)

(72) Inventors: Keala Gaines, San Jose, CA (US); Paulam Chang, San Jose, CA (US); Kalpesh Ashok Doshi, San Jose, CA (US)

(21) Appl. No.: 14/699,906

(22) Filed: Apr. 29, 2015

Related U.S. Application Data
(60) Provisional application No. 61/993,580, filed on May 15, 2014.

(51) Int. Cl. G06Q 20/12; G06Q 30/06

(52) U.S. Cl. CPC G06Q 20/12; G06Q 30/0641

(57) ABSTRACT

There is provided systems and method for selection of merchant and device specific payment flow. A merchant may access a payment provider and make selections for a payment flow that a consumer utilizes during check-out and payment for items from the merchant. The payment flow may include a merchant category, a language for presentation of the payment processing information, when the user is required to log-in to the payment provider, custom logos and styles for the merchant, etc. The merchant may also view how the payment flows appear on different device platforms, such as mobile devices, tablet/desktop computers, as well as various operating systems and/or Internet browsers. Once a selection of the various parameters for the payment flow is made by the merchant, a custom payment flow may be generated for the merchant. The merchant may browse the pages of the interface as well as receive downloadable code and best practices associated with the features of the interface.

### CROSS REFERENCE TO RELATED APPLICATION

This application claims priority to U.S. Provisional Patent Application Ser. No. 61/993,580, filed May 15, 2014, which is hereby incorporated by reference in the aforementioned application's entirety.

### TECHNICAL FIELD

Example embodiments of the present application relate generally demonstration of service provider services using interactions between devices in a computer network, and more specifically to selection of merchant and device specific payment flows.

### BACKGROUND

A merchant may wish to provide online payments to the merchant through a payment provider. The payment provider may provide payment services, including payment card processing, payment accounts for a consumer and the merchant, escrow services, and other payment and merchandise related services. However, for certain merchants, generalized payment services through the payment provider may be inadequate for the merchant's consumers. For example, different types of merchants may require different payment flows during checkout with the merchant. A payment flow may correspond to a set of webpages and/or instructions that effectuate the payment to the merchant. Thus, a payment flow for an online movie or music merchant may be substantially different from a payment flow for a big box retailer who may require delivery addresses and/or signing information for packages. Moreover, merchants may wish to customize the presentation of the payment flow to incorporate merchant logos, styles, languages, etc.

### BRIEF DESCRIPTION OF THE DRAWINGS

FIG. 1 is a block diagram of a networked system suitable for implementing the process described herein, according to an embodiment;

FIG. 2 is an exemplary demo website portal of a payment provider where a merchant may select and view various payment flows through options provided by the payment provider, according to an embodiment;

FIG. 3A is an exemplary merchant checkout interface on a device after selection of payment flow options by a merchant, according to an embodiment;

FIG. 3B is an exemplary merchant checkout interface on a device after selection of payment flow options by a merchant, according to an embodiment;

FIG. 3C is an exemplary merchant checkout interface on a device after selection of payment flow options by a merchant, according to an embodiment;

FIG. 3D is an exemplary portal provided by a payment service provider where a merchant may generate a payment flow during a checkout process, according to an embodiment;

FIG. 3E is an exemplary portal provided by a payment service provider where a merchant may generate a payment flow during a checkout process, according to an embodiment;

FIG. 3F is an exemplary portal provided by a payment service provider where a merchant may generate a payment flow during a checkout process, according to an embodiment;

FIG. 4 is a flowchart of an exemplary process for selection of merchant and device specific payment flow, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for selection of merchant and device specific payment flows. Systems suitable for practicing methods of the present disclosure are also provided.

In various embodiments, a payment provider may enable a merchant to make selections of options to view and/or build a payment flow for use during check-out and payment for one or more items (e.g., merchandise, goods, services, etc.) on the merchant's website by a user wishing to purchase the item(s). The payment provider may provide a demonstration or demo portal, for example, through a website of the payment provider, to view and/or build the payment flow. A payment flow may correspond to one or a set of webpages, application interfaces, selectable webpage/application elements, and/or correspond instruction that are presented to a user (e.g., a consumer) when the user attempts to pay for selected items with the merchant. The payment flow may enable the user to enter a payment instrument, provide billing/shipping addresses, select escrow and/or insurance services, and complete other check-out and/or payment related processes. The payment instrument may also include a payment account with the payment provider, so that the payment flow allows for login to the payment account during the merchant's checkout process to provide payment to the merchant using the payment account. Thus, selection of a payment flow may customize the check-out and payment processes presented to the user on the merchant's website.

When selecting a payment flow, the merchant may view a plurality of payment flow options corresponding to a type/category of merchant, a website login preference (e.g., when the user is required to a payment account with the payment provider), a language for the information, a region for the merchant and/or user (e.g., acceptable shipping and/or billing regions, a type of device and/or platform used to access the merchant checkout interface/process (e.g., login through a mobile device, where the merchant provides a mobile website, login through a desktop and a conventional website, login and payment through a dedicated merchant application for the merchant, etc.). The merchant may also upload and select a merchant logo, and a merchant style. The merchant may also designate acceptable shipping addresses, signing persons if a signature is required, receipt information, and exchange and/or refund information. Once the merchant has selected a plurality of options and other parameters for the payment flow, a payment flow may be generated for the merchant based on the selections made by the merchant. The payment flow may be specific (e.g., customized) to the merchant, and may be further customizable through changes and further selections by the merchant. The payment provider may provide a custom URL that may be shared between the payment provider and the merchant to view the payment flow, or the merchant may view the payment flow through the demo portal provided by the payment provider for generation of the payment flow.

During generating of the payment flow for use in a merchant checkout process for a merchant website (e.g., accessible through a browser application of a device and/or a dedicated application of the merchant), the demo portal provided by the website of the payment provider may assist the merchant in making selections of payment flow options based on received, determined, and/or accessed information for the merchant. For example, the region of the merchant may be selected based on at least one of a top-level domain name used to access the website providing the demo portal, an IP address of the merchant, and merchant location information. The region of the merchant may cause different payment flows to be generated, or may present different payment flow options, for example, based on regional differences in services offered by the payment provider and/or regional requirements for payment laws and requirements. Additionally, the type or category of merchant may be selected based on merchant information including one or more of a product type sold by the merchant, a regional presence of the merchant, revenue of the merchant, revenue streams of the merchant, and an amount of products sold by the merchant The category of merchant may affect the type of payment flow options offered and/or the generation of the payment flow. For example, a big box retailer may have different requirements during checkout and payment than small retailers offering more limited items for sale. Thus, the demo portal may make intelligent decisions and offer corresponding options based on available information.

During and/or after generation of the payment flow, the merchant may make selections of platforms to view the payment flow on using the demo portal. The platforms may correspond to a device type, such as a desktop, mobile device, tablet, etc., or may correspond to utilizing a merchant checkout process available from a merchant website through a browser application or a dedicated device application. The merchant may switch the type of platform to view the payment flow in each of the various platforms. The payment flow may be generated for each platform (or for only selected platforms).

The payment flow may include instructions, webpages, application interfaces, webpage/application interface fields that accept information on each webpage, and a progression through the webpages/interfaces that guides a user through the payment and checkout process. The webpages/interfaces may each include the information necessary for the user while checking out and the webpage/interface fields to accept the user's payment account information with the payment provider, payment instrument, shipping information, etc. The information and progressions may be presented based on the selections of the options and parameters for the payment flow made by the merchant. Thus, the language, type of merchant, merchant styles/logos, etc., may all be presented to the end user through the selected payment flow when the user attempts to checkout and pay for items with the merchant. The merchant may view the instructions, webpages, interfaces, and progression in order to make changes, add, and/or delete material. The merchant may also view a panel or presentation window of all of the webpages/interfaces for the custom payment flow so that the merchant may navigate between webpages/interfaces using the demo portal (e.g., a navigation pane). Selection of other payment flows and/or parameters may change the custom payment flow so that a different payment flow and/or options will be displayed to the user. The merchant may therefore view a plurality of payment flows by altering the merchant's selections. In various embodiments, the custom payment flow may be specific to a merchant's dedicated application for a device instead of a merchant website, as discussed herein.

The merchant may also be presented with a toolbar or other display of a plurality of different device platforms that a user may utilize to access the merchant's website. By choosing one of the device platforms, the merchant may be able to view the custom payment flow on that device platform. The merchant may also make selections of various payment flows for each device platform, so that the merchant may customize the payment flow based on the device platform a user utilizes to access the merchant's website and pay for selected items (e.g., items chosen in a shopping cart). The merchant may then customize the user's checkout and payment experience based on the easiest and/or most suitable processes for the device platform. For example, it may be more difficult to type an email address using a mobile device. Thus, when the merchant requests an email address during checkout for the credentials of the user's payment account with the payment provider, the email address may be automatically populated based on information in the mobile device's email application.

The custom payment flow may also include code and best practices selection tools. By selecting the code tool associated with a feature, information, and/or field presented on a webpage, or with the webpage/custom payment flow in general, the merchant may view in-context downloadable code samples for the custom payment flow. Thus, the merchant is enabled to view, copy, and/or inspect the code associated with the selected payment flow and custom payment flow for integration into the merchant's website. The merchant may also make selections of features, webpage fields, etc., with a best practices tool so that the user may view the payment providers best practices associated with that field. Best practices may show the merchant what the most efficient, responsive, or highest rated practices are with a particular feature/field/webpage so that the merchant may provide a more user friendly payment flow. Therefore, a merchant is able to easily create and visualize a desired payment flow for different devices and different customizable features for a specific merchant type, language, country, and other parameters before presenting the payment flow live to the merchant site. The merchant may, after generation of a payment flow for the merchant website, execute a dynamic checkout experience allowing for the merchant to test run the payment flow on the merchant website through the portal. The merchant may supply test information, such as a test checkout cart and account information, and view how a user would checkout and pay with the merchant using the payment flow.

In various embodiments, one or more payment flow options and/or frameworks for a payment flow for use in a merchant checkout process may be restricted to certain merchants, such as white listed merchants (e.g., certain pilot/preferred merchants and/or early integration merchants). Thus, the payment provider may require login to an invitation only demo portal to access the options/flows. Additionally, the merchants may login or provide other identification to build a merchant portal, which may include merchant information used to make payment flows. The merchant and/or developers may also receive framework payment flows with associated computer code, where the merchant/developers may develop a customized payment flow. The customized payment flow and/or additional code may be uploaded to the payment provider and offered to other merchants/developers through an open source portal.

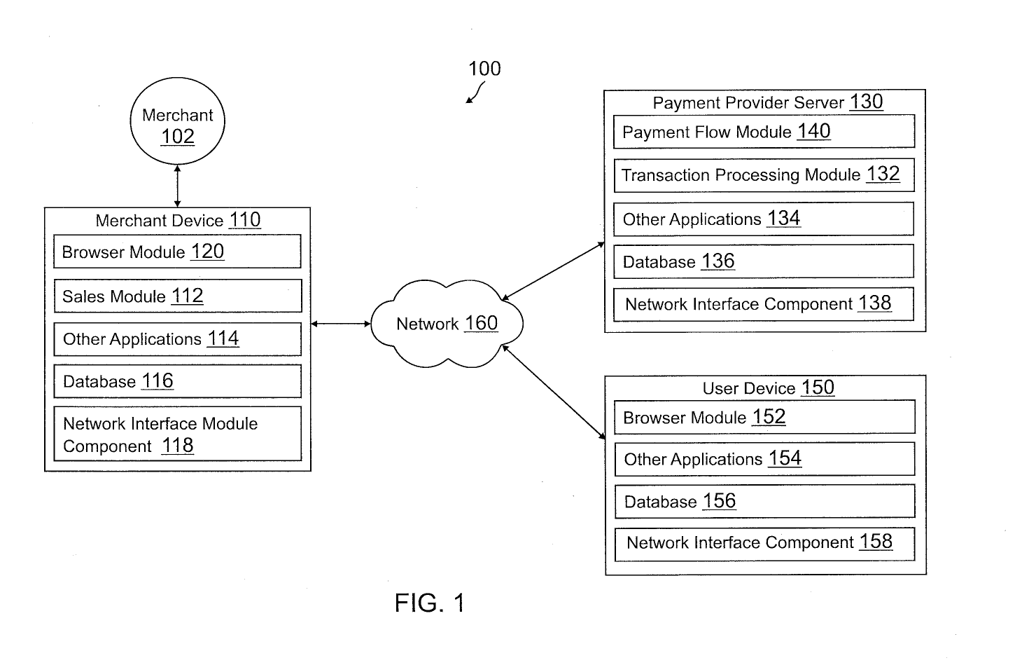

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways'and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a merchant 102, a merchant device 110, a payment provider server 130, and a user device 150 in communication over a network 160. Merchant 102, such as a consumer, may utilize merchant device 110 to visit payment provider server 130 and select a payment flow for checkout and payment of items by a consumer when the consumer visits a merchant website for merchant 102. The selection of the payment flow may generate a custom payment flow, which may be utilized by the merchant's website. The consumer may then utilize user device 150 to visit the website and utilize the custom payment flow.

Merchant device 110, payment provider server 130, and user device 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Merchant device 110 may be implemented using any appropriate hardware and software configured for wired and/or wireless communication with payment provider server 130 and/or user device 150. For example, in one embodiment, merchant device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. Although a merchant device is shown, the merchant device may be managed or controlled by any suitable processing device (e.g., a server and/or cloud computing system). Although only one merchant device is shown, a plurality of merchant devices may be utilized.

Merchant device 110 of FIG. 1 contains a browser module 120, a sales module 112, other applications 114, a database 116, and a network component interface. Browser module 120, sales module 112, and other applications 114 may correspond to executable processes, procedures, and/or applications with associated hardware. In other embodiments, merchant device 110 may include additional or different software as required.

Browser module 120 may correspond to one or more processes to execute modules and associated specialized hardware of merchant device 110 to provide a convenient interface to permit merchant 102 to browse the Internet, including navigation to websites and between webpages of websites. Browser module 120 may correspond to specialized hardware and/or software configured to transmit and receive information, such as webpage requests, input to webpages, downloads and uploads of data in database 116 of merchant device 110, etc. Thus, when merchant device 110 is connected to network 160, browser module 120 may communicate information over network 160. Such information may be communicated with payment provider server 130. In such embodiments, merchant 102 may utilize browser module 120 to access a website of payment provider server 130 and view webpages one the website. Merchant 102 may transfer data with the website provided by payment provider server 130, including transmitting selections of payment flows and/or other information to payment provider server 130 and receiving viewable webpage, including a custom payment flow, executable code, and other information from payment provider server 130.

Thus, browser module 120 may enable merchant 102 to make selections of payment flow parameters/options from a plurality of payment flows presented to merchant 102 through browser module 120. Once merchant 102 has made the selection(s), payment provider server 130 may present a custom payment flow to merchant 102 through browser module 120, as will be explained in more detail herein. The custom payment flow may incorporate a layout enabling merchant 102 to navigate to webpages/windows/features of the custom payment flow using browser module 120. Additionally, merchant 102 may utilize browser module 120 to download the custom payment flow, best practices for implementing the custom payment flow, and/or executable code for inserting the custom payment flow into a website of merchant 102.

In certain embodiments, browser module 120 may utilize payment provider server 130, such as PAYPAL® of San Jose, Calif., to provide payment and/or establish a payment account with payment provider server 130. Browser module 120 may also include or correspond to a dedicated payment application, including one offered by PAYPAL®. In such embodiments, the payment application may also be configured to enable merchant 102 to select the payment flow and interact with the custom payment flow, as discussed above.

Sales module 112 may correspond to one or more processes to execute modules and associated specialized hardware of merchant device 110 to provide a convenient interface to permit merchant 102 to enter, view, edit, and/or present information for items and/or services offered by merchant 102 for sale to consumers. In this regard, sales module 112 may correspond to specialized hardware and/or software that may be implemented as a website or merchant marketplace that a consumer may visit in order to purchase items (e.g., merchandise, goods, services, etc.). In this respect, sales module 112 may access database 116 having available items for purchase from merchant 102 with corresponding item information. The item information may include price, description, available inventory, sales/discount information, etc. Sales module 112 may correspond to a website for a specific merchant (e.g., a retail provider) or may correspond to an online marketplace where a plurality or merchants and/or users may sell items (e.g., EBAY® and/or STUBHUB®). In other embodiments, sales module 112 may correspond to an application configured to interact with a dedicated user device application for a merchant (e.g., an application for a retail merchant on a mobile phone). In such embodiments, sales module 112 may transfer data between the dedicated device application for presentation and sale of items available with merchant 102.

Sales module 112 may integrate a custom payment flow offered by payment provider server 130. Thus, after merchant 102 utilizes browser module 120 to select at least one payment flow from a plurality of payment flows, merchant 102 may view a custom payment flow for use with sales module 112. The custom payment flow may be integrated by payment provider server 130 or may be implemented into sales module 112 from executable code received by merchant 102. Once the custom payment flow is integrated into sales module 112, a consumer may utilize the payment flow on checkout and payment for selected items for purchase from merchant 102. The payment flow enables the consumer to provide payment through payment provider server 130 to merchant 102.

In various embodiments, one or more features of browser module 120 and sales module 112 may be incorporated the same application so as to provide their respective features in one application interface.

Merchant device 110 includes other applications 114 as may be desired in particular embodiments to provide features to merchant device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160. In various embodiments, other applications 114 may include financial applications, such as banking, online payments, money transfer, or other applications associated with payment provider server 130. Additionally, other applications 114 may include social media and/or mapping applications. Other applications 114 may contain other software programs, executable by a processor, including a graphical user interface (GUI) configured to provide an interface to the user.

Merchant device 110 may further include database 116 which may include, for example, identifiers such as operating system registry entries, cookies associated with browser module 120, sales module 112, and/or other applications 114, identifiers associated with hardware of merchant device 110, or other appropriate identifiers, such as identifiers used for payment/user/device authentication or identification. In one embodiment, identifiers in database 116 may be used by payment provider server 130 to associate merchant device 110 with a particular account maintained by payment provider server 130.

In various embodiments, database 116 may further include information for sales module 112. For example, database 116 may include available item information for items purchasable from merchant 102. Thus, database 116 may include item name, description, price, inventory, etc. Database 116 may include information necessary for a consumer to complete a purchase for one or more items, such as a custom payment flow for sales module 112 for use with payment provider server 130. Database 116 may further include sales information for complete sale transactions by the consumer, including transaction histories, shipping information, etc.

In various embodiments, merchant device 110 includes at least one network interface component 118 adapted to communicate with payment provider server 130 and/or user device 150. In various embodiments, network interface component 116 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Payment provider server 130 may be maintained, for example, by an online payment service provider, which may provide payment services for users (e.g., consumers) and/or merchants. In this regard, payment provider server 130 includes one or more processing applications, which may provide payment for items between merchant device 110 and user device 150. In one example, payment provider server 130 may be provided by PAYPAL®, Inc. of San Jose, Calif., USA. However, in other embodiments, payment provider server 130 may be maintained by or include a merchant, financial services provider, and/or other service provider, which may provide payment services to merchant 102. Payment provider server 130 may additionally provide use of payment accounts for payment of items. Payment accounts may be utilized by a user and merchant to send and receive payments. Although payment provider server 130 is described as separate from merchant device 110, it is understood that a merchant, merchant device 110, and/or merchant server may include one or more features provided by payment provider server 130.

Payment provider server 130 of FIG. 1 includes a payment flow module 140, a transaction processing module 132, other applications 134, a database 136, and a network interface component 138. Transaction processing module 132 and other applications 134 may correspond to executable processes, procedures, and/or applications with associated hardware. In other embodiments, payment provider server 130 may include additional or different software as required.

Payment flow module 140 may correspond to one or more processes to execute modules and associated specialized hardware of payment provider server 130 to provide a website having a demo portal interface and/or application enabling merchant 102 to select one or more payment flows from a plurality of payment flows offered by payment provider server 130. In this regard, payment flow module 140 may correspond to specialized hardware and/or software of payment provider server 130 to access one or more payment flow options for generating a payment flow for use in a merchant checkout process on a merchant website for merchant 102. A payment flow may correspond to information, webpages, application interfaces and/or features presented to a user during a checkout and/or payment process with a merchant in order to purchase items from the merchant. Thus, a payment flow may include one or more of a type/category of merchant, a website login preference (e.g., when the user is required to a payment account with the payment provider), a language for the information, a region for the merchant and/or user (e.g., acceptable shipping and/or billing regions, etc.). A payment flow may also include a merchant logo, a merchant style, acceptable shipping addresses, acceptable signing persons if a signature is required, receipt information, and exchange and/or refund information. Thus, a plurality of payment flow options may be presented to merchant 102 by payment flow module 140 so that merchant 102 may make selections of preferable payments flows that merchant 102 would like to utilize during the checkout and payment process with merchant 102 (e.g., on a website or through an application for merchant 102).

Selection of one or more of the options for the payment flows (e.g., selecting English as the preferred language presented during checkout, selecting that the merchant is a Big Box retailer, selection of login on payment) may cause payment flow module 140 to present a custom payment flow to merchant 102. Selection of an option may be done intelligently (e.g., a region and/or category of merchant), based on the top-level domain name accessing payment flow module 140, merchant location information, an IP address for the merchant, merchant financial and sale information, and/or other information. Merchant 102 may browse the custom payment flow by viewing a webpage or webpages for the custom payment flow or viewing a window or windows presented to a user in a device application for the custom payment flow. For example, merchant 102 may be presented with one or more webpages or application windows presenting a checkout and payment flow customized for merchant 102 based on selected payment flows by merchant 102. The webpage(s)/application window(s) may include the preferred language, interface for the merchant type, merchant logos, etc. Merchant 102 may navigate throughout the custom payment flow through a navigation pane that includes one or more of the webpage(s)/window(s) for selection by merchant 102. Merchant 102 may also view how the custom payment flow appears on various device platforms, such as a mobile phone, a tablet computer, a device application, a web browser, a wearable computing device platform, etc. Merchant 102 may also configured the custom payment flow for each device platform by refining and/or changing the payment flows specific to that device platform. Payment flow module 140 may also provide a tool to utilize with features, input boxes/menus, and/or webpages that shows best practices for the custom payment flow and/or payment flow options.

As previously discussed, merchant 102 may also receive the custom payment flow from payment flow module 140. While constructing the custom payment flow from a plurality of payment flows, merchant 102 may receive a custom URL that may be shared between the payment provider and the merchant to view the selected payment flow and the custom payment flow. The payment flow in the demo portal of payment flow module 140 retrievable through the website provided by payment provider server 140 may correspond to a demonstration of the payment flow in a merchant website, include the merchant's website, and may allow the merchant to construct the payment flow into their website. Further, payment flow module 140 may make the executable code and/or a downloadable file, document, etc., available for merchant 102 to retrieve and implement in merchant 102's website or application. The custom payment flow and/or options for customizing the payment flow may also be displayed with various tools, which may include resource tools for assistance in implementing the payment flow into a website for the merchant and/or a checkout process for the merchant The tools may also include a best practices tool having tips and other advice used to implement the payment flow into a merchant website and additional information to more easily integrate the payment flow or provide better or easier payment flows during the checkout process for the merchant.

In various embodiments, the custom payment flow presented through the demo portal of payment flow module 140 may also be interactive so that the elements, options, features, and/or webpages/interfaces are dynamic. In such embodiments, the demo portal may allow for the merchant to run test information through the customized payment flow so that the merchant may test how a checkout and payment process works using the payment flow. The test information may include a test transaction and/or test login credentials. Thus, the merchant may experience the payment flow as a customer would during checkout. Merchant 102 may further customize the payment flow based on such dynamic experiences.

Payment flow module 140 may also allow for an administrator or other entity to establish an invitation only payment flow demo, where the payment flow options and/or payment flows are usable only by specific merchants. For example, merchant 102 may be on a white list of private or preferred merchants and/or be part of a pilot/early integration program that may view certain payment flow options and/or payment flows. Thus, payment flow module 140 may require a login to certain features of the demo portal offered by payment flow module 140. In further embodiments, the login may be used to establish a profile for merchant 102, which may include merchant information used to customize a payment flow for merchant 102. The profile may also be used to provide framework payment flows with corresponding computer code to merchant 102 and/or a developer associated with merchant 102. Merchant 102 and/or the developer may then add additional code and develop the framework to create a personalized or specific payment flow for merchant 102. The specific payment flow may be uploaded to payment flow module 140, and shared as open source code through a platform and/or demo portal provided by payment flow module 140.

Transaction processing module 132 may correspond to one or more processes to execute modules and associated specialized hardware of payment provider server 130 to receive and/or transmit information from merchant device 110 and/or user device 150 for processing and completion of financial transactions. In this regard, transaction processing module 132 may correspond to specialized hardware and/or software of payment provider server 130 to process financial transaction information. Transaction processing module 132 may receive a request to complete a sale transaction for an item with merchant device 110 (or corresponding merchant server) and user device 150. Transaction processing module 132 may complete the sale transaction by providing payment to merchant 102 from user device 150. Additionally, transaction processing module 132 may provide transaction histories, including receipts, for use by merchant device 110 and/or user device 150 to complete a financial transaction.

In various embodiments, payment provider server 130 includes other applications 134 as may be desired in particular embodiments to provide features to payment provider server 130. For example, other applications 134 may include security applications for implementing server-side security features, programmatic server applications for interfacing with appropriate application programming interfaces (APIs) over network 160, or other types of applications. Other applications 134 may contain software programs, executable by a processor, including a graphical user interface (GUI), configured to provide an interface to a user.

Additionally, payment provider server 130 includes database 136. As previously discussed, merchant 102 and a user/consumer corresponding to user device 150 may establish one or more payment accounts with payment provider server 130. Payment accounts in database 136 may include user information, such as name, address, birthdate, payment/funding information, additional user financial information, and/or other desired user data, including user identifiers/tokens for use in identifying the payment account. Merchant 102 and the user/consumer may link payment accounts to merchant device 110 and/or user device 150 through a user device identifier. Thus, when a device identifier corresponding to merchant device 110 is transmitted to payment provider server 130, e.g. from merchant device 110 and/or merchant server 120, a user account belonging to merchant 102 may be found. In other embodiments, merchant 102 and/or the user/consumer may not have previously established a payment account and other financial instrument or information may be provided

In various embodiments, payment provider server 130 includes at least one network interface component 138 adapted to communicate with merchant device 110 and/or user device 150 over network 160. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

User device 150 may be implemented using any appropriate hardware and software configured for wired and/or wireless communication with merchant device 110 and/or payment provider server 130. For example, in one embodiment, user device 150 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. Although a user device is shown, the user device may be managed or controlled by any suitable processing device. Although only one user device is shown, a plurality of user devices may function similarly.

User device 150 of FIG. 1 contains a browser module 152, other applications 154, a database 156, and a network interface component 158. Browser module 152 and other applications 154 may correspond to executable processes, procedures, and/or applications with associated hardware. In other embodiments, user device 150 may include additional or different software as required.

Browser module 152 may correspond to one or more processes to execute modules and associated specialized hardware of user device 150 to provide a convenient interface to permit a consumer corresponding to user device 150 to browse the Internet, including navigation to websites and between webpages of websites. In this regard, browser module 152 may correspond to specialized hardware and/or software of user device 150 that may be configured to transmit and receive information, such as webpage requests, input to webpages, downloads and uploads of data in database 156 of user device 150, etc. Thus, when user device 150 is connected to a network, browser module 152 may utilize network 160 to connect to merchant device 110 and/or a server corresponding to merchant 102 and view a website for items offered by merchant 102. The consumer may utilize browser module 152 to make selections of items available from merchant 102. Once the consumer is ready to checkout and pay for the items, browser module 152 may display the custom payment flow for merchant 102. The consumer may then provide payment, shipping, and other necessary information to complete a payment to merchant 102 using the custom payment flow and payment provider server 130.

User device 150 includes other applications 154 as may be desired in particular embodiments to provide features to user device 150. For example, other applications 154 may include security applications for implementing client-side security features, programmatic client applications for interfacing with appropriate application programming interfaces (APIs) over network 160, or other types of applications. Other applications 154 may also include email, texting, voice and IM applications that allow a user to send and receive emails, calls, texts, and other notifications through network 160. In various embodiments, other applications 154 may include financial applications, such as banking, online payments, money transfer, or other applications associated with a payment provider server. Other applications 154 may include social networking and/or mapping applications. Other applications 154 may contain software programs, executable by a processor, including a graphical user interface (GUI) configured to provide an interface to the user.

User device 150 may further include database 156 which may include, for example, identifiers such as operating system registry entries, cookies associated with browser module 152 and/or other applications 154, identifiers associated with hardware of user device 150, or other appropriate identifiers, such as identifiers used for payment/user/device authentication or identification. Identifiers in database 156 may be used by a payment/service provider to associate user device 150 with a particular account maintained by the payment/service provider.

User device 150 includes at least one network interface component 158 adapted to communicate with merchant device 110 and/or payment provider server 130 over network 160. In various embodiments, network interface component 158 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

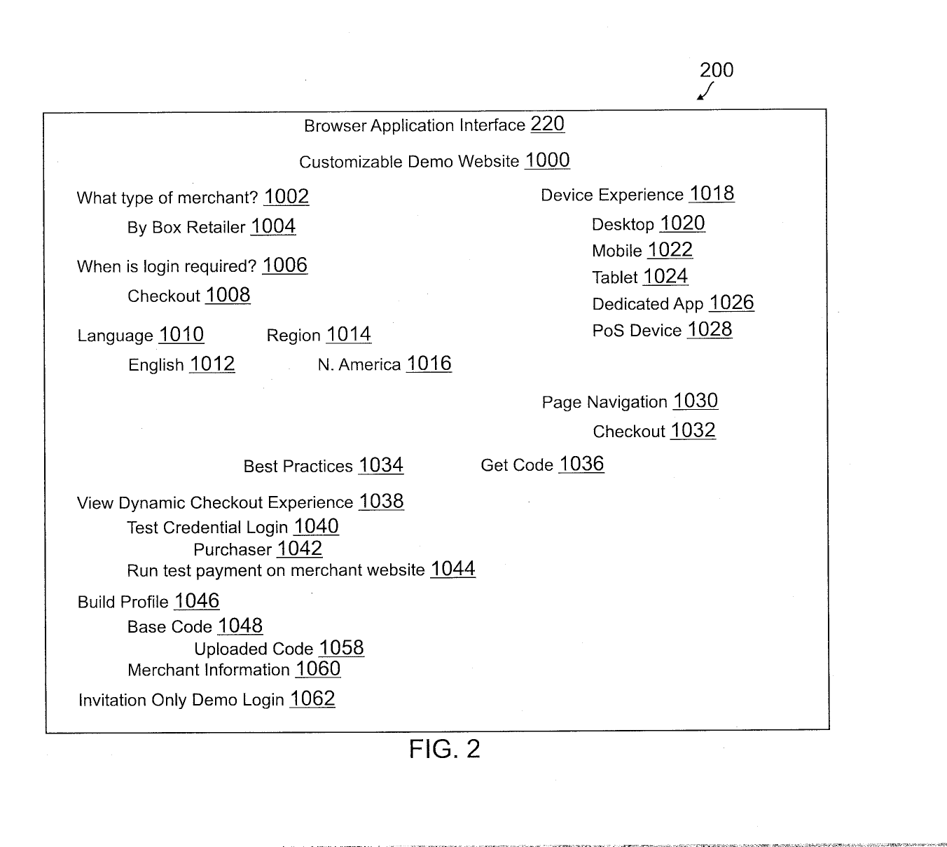

FIG. 2 is an exemplary demo website portal of a payment provider where a merchant may select and view various payment flows through options provided by the payment provider, according to an embodiment. A browser application interface 220 may correspond generally to the described features executed by specialized hardware and/or software of browser module 120 in environment 100 of FIG. 1.

Browser application interface 220 may display information available over a network from a payment provider, such as payment provider server 130 in environment 100. Browser application interface 220 displays a demo portal from a website of the payment provider. The demo portal may be displayed as a customizable demo website 1000. Customizable demo website 1000 includes information that may be displayed to a merchant as well as selectable payment flow options. For example, the selectable payment flow options may include an option to select a type of merchant 1002, shown as a big box retailer 1004. In various embodiments, big box retailer 1004 may be selected based on information supplied by the merchant to the payment provider. Additionally, the merchant may select when login is required at 1006 by the user, such as at checkout 1008. The merchant may select or the payment provider may automatically fill payment flow options for language 1010 and region 1014, for example, English 1012 and North America 1016, respectively. Additional payment flow options may include a selection of a type of device experience 1018, which may include desktop 1020, mobile 1022, tablet 1024, a dedicated application 1026, and a point of sale device 1028. As shown in environment 200, the merchant has selected mobile 1022 so that page navigation 1030 may be displayed, which may include a current page checkout 1032.

After selection of a payment flow option, best practices 1034 and get code 1036 may populate, which may include information panes and/or expandable boxes including the aforementioned information. Additionally, the merchant may be given options to view dynamic checkout experience 1038, for example, by entering test credential login 1040 (e.g., a purchaser 1042 login) and/or selecting to run test payment on merchant website 1044. In various embodiments, the merchant may further build a profile 1046 using merchant information 1060, which may be utilized with a framework payment flow having based code 1048 as well as uploaded code 1058 from the merchant or a developer. The merchant may also be required to login in certain embodiments to access certain features of customizable demo website 1000, for example, through invitation only demo login 1062.

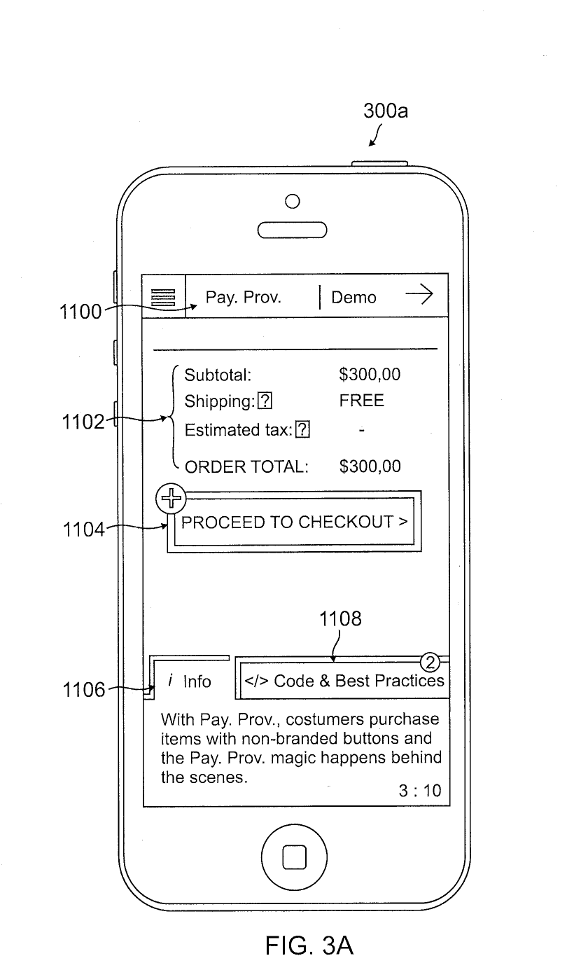

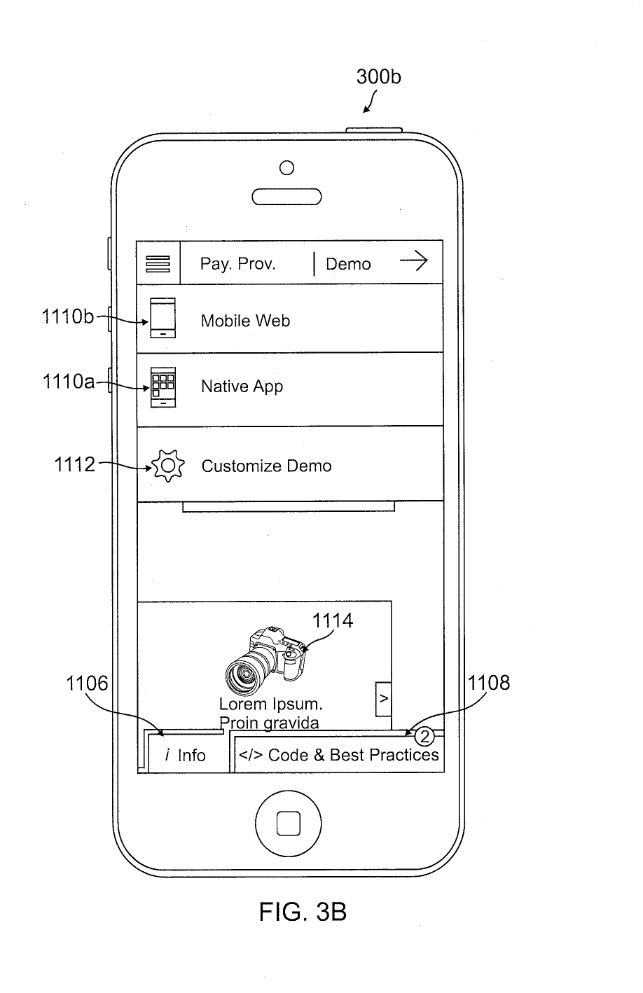

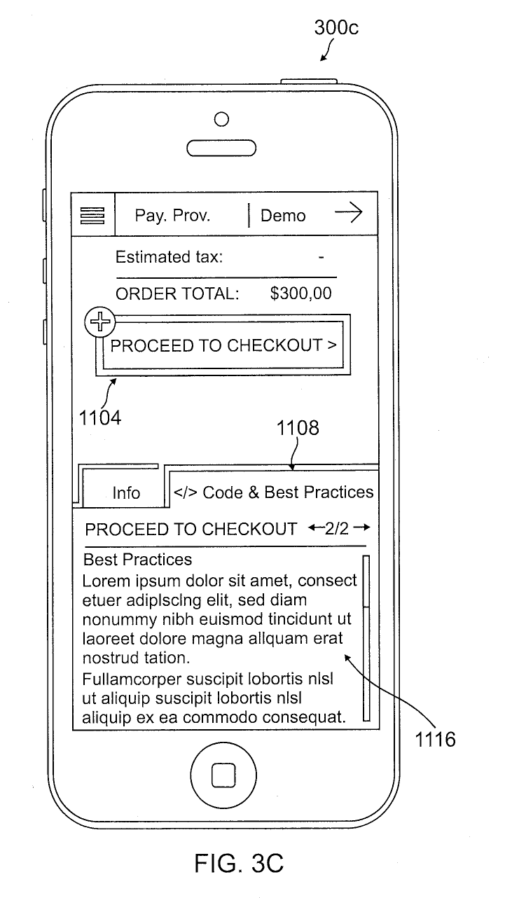

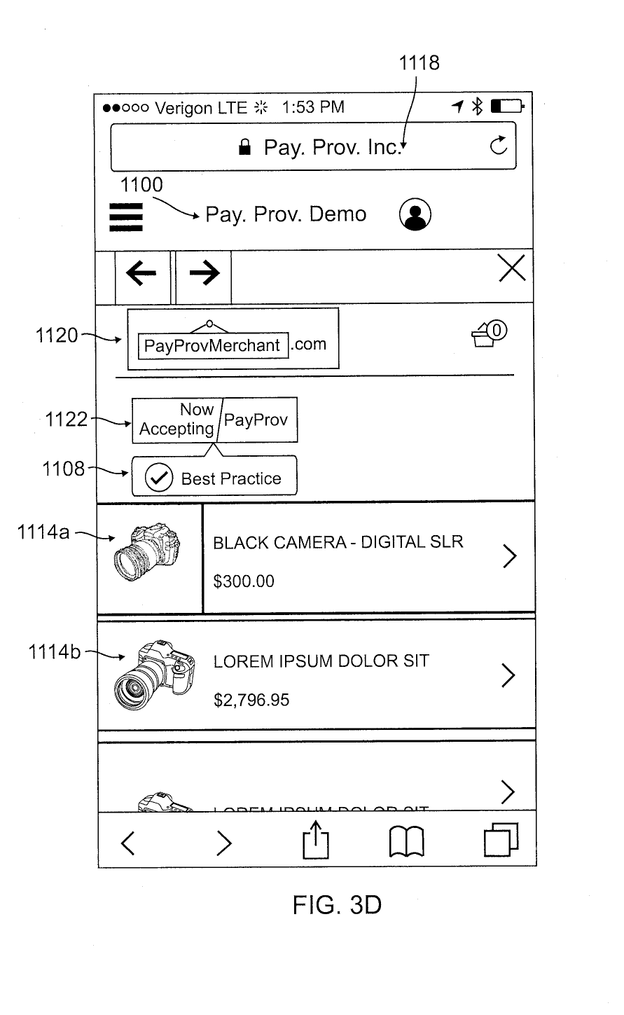

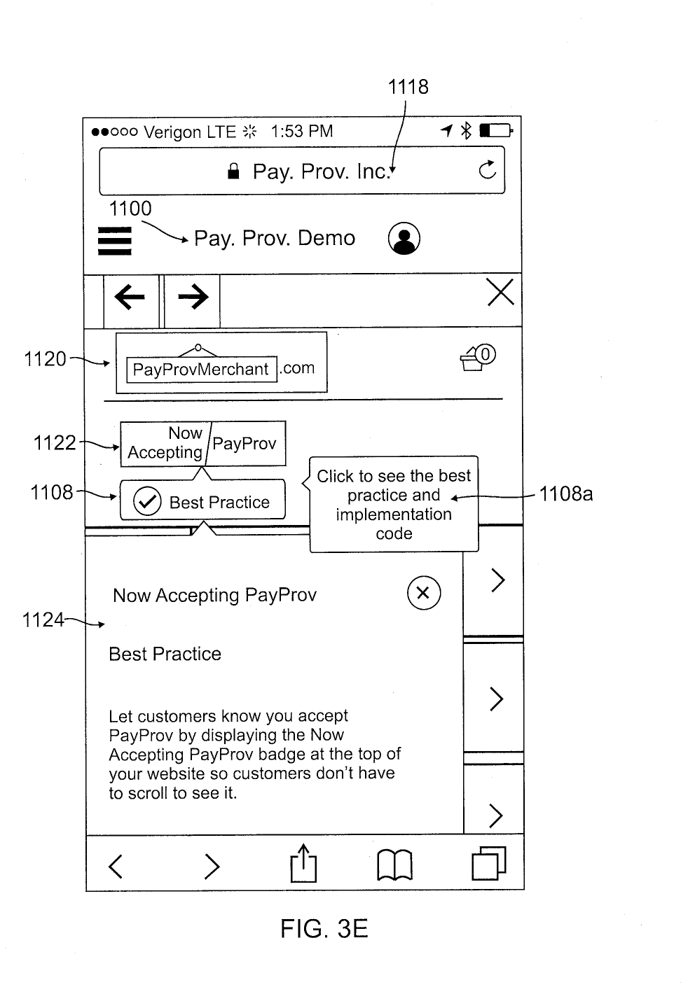

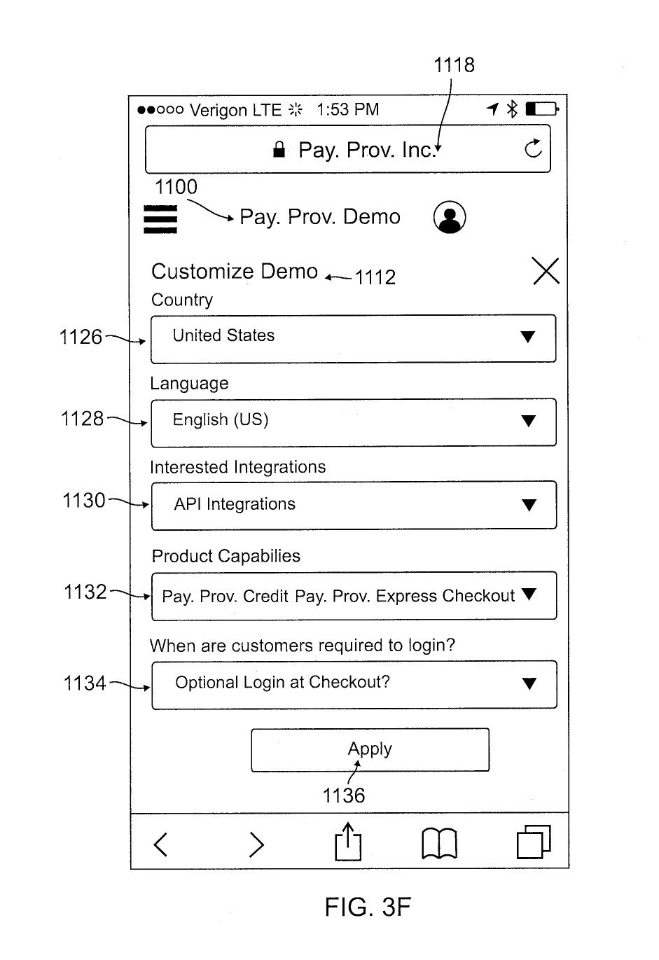

FIG. 3A is an exemplary merchant checkout interface on a device after selection of payment flow options by a merchant, according to an embodiment. In various embodiments, device interface 300a may correspond to a mobile device having the interface, or may correspond to a displayable virtual device mimicking a mobile device having the interface, for example, within a demo portal offering payment flows for use with accessing the merchant website/application using the mobile device.

A device interface 300a is shown as it would appear when accessing a merchant checkout process for a merchant website/application having a payment flow determined based on selected payment flow options by the merchant. For example, device interface 300a includes a checkout interface, where a digital shopping cart having items for purchase may be displayed. Payment is offered through a payment provider 1100, which may perform payment processing for a total 1102. Device interface 300a further includes a checkout button 1104, which may be displayed and selected by a customer to continue payment processing.

Device interface 300a further displays tools and information provided by a demo portal generating the payment flow. For example, an informational tool 1106 may display information conveyed to a merchant to assist the merchant in selection of one or more payment flow options and/or payment provider services. Moreover, a code/best practices tool 1108 may be displayed on selection to the merchant Code/best practices tool 1108 may display computer code used to implement the payment flow and/or the webpage/payment flow displayed on device interface 300a to the merchant within the merchant's website/application. Code/best practices tool 1108 may also display best practices for implementing the payment flow and/or for providing payment services to consumers using payment provider 1100. The merchant may select informational tool 1106 and/or code/best practices tool 1108 during viewing and browsing of the payment flow to receive information for tailoring the payment flow to the merchant's needs and implementing the payment flow within a website/application for the user.

Selection of a dropdown menu for platform types may allow for the merchant to view a device interface 300b in FIG. 3B. FIG. 3B is an exemplary merchant checkout interface on a device after selection of payment flow options by a merchant, according to an embodiment.

As shown on device interface 300b, the merchant may select from a mobile web platform 1110a used with a mobile device when utilizing a browser application of the mobile device to process a payment to the merchant. The merchant may also switch to a native application platform 1110b, such as a dedicated application of the merchant for shopping/payment, using device interface 300b. Thus, the merchant may switch platforms to view differing payment flows. The merchant may also further enter selectable payment flow options by selecting to customize 1112, for example, by switching merchant regions, types, etc. Device interface 300b may therefore vary the layout and look of a sales interface 1114 of the merchant checkout process using the merchant website/application through selection of 1110a, 1110b, and/or 1112. Moreover, the merchant may again view informational tool 1106 and/or code/best practices tool 1108 while browsing through the various payment flows to receive additional information, best practices, and/or computer code.

For example, the merchant may continue to view mobile web platform 1110a on a device interface 300c of FIG. 3C. FIG. 3C is an exemplary merchant checkout interface on a device after selection of payment flow options by a merchant, according to an embodiment.

Device interface 300c includes checkout button 1104, which the merchant may wish to implement into the mobile web platform 1110a's payment flow. In order to do so, the merchant may require computer code and/or best practices to implement checkout button 1104 as a feature in the merchant's website for web platform 1110a. Thus, the merchant may select code/best practices tool 1108 to receive information in implementation of checkout button 1104 for checkout and payment using payment provider 1100. After selection of code/best practices tool 1108, practice tips 1116 may be displayed to the merchant, which may be used in order to implement checkout button 1104 and the corresponding features to the merchant's mobile website.

FIG. 3D is an exemplary portal provided by a payment service provider where a merchant may generate a payment flow during a checkout process, according to an embodiment. In FIG. 3D, an exemplary demo portal offered by a payment provider is shown where a merchant may make selections of payment flow options to generate a payment flow used during checkout with the merchant. Thus, the demo portal shown in FIG. 3D includes exemplary but non-limiting payment flow options and information displayed to the merchant while utilizing the demo portal.

The demo portal in FIG. 3D is offered by payment provider 1100, for example, from a payment provider website 1118. The demo portal may be established to present an exemplary checkout process for use with the merchant's website or dedicated device application using the payment provider as a payment processing entity. Thus, the demo portal displays what the personalized payment flow may look like on a merchant's website 1120. For example, the demo portal may provide for a payment provider tag 1122 that informs users of the merchant's website 1120 that payment provider 1100 is accepted as a form of payment through merchant's website 1120. Payment provider tag 1122 may be included with code/best practices tool 1108, which may be utilized to read best practices associated with payment provider tag 1122 and/or receive code to implement one or more of the payment flow options into merchant's website 1120. Additionally, the demo portal of FIG. 3D includes a sale item 1114a and a sale item 1114b in a sales interface that a user may browse when selecting items to purchase. Thus, the payment flow developed for the merchant's checkout process may be used with sale item 1114a and/or sale item 1114b.

FIG. 3E is an exemplary portal provided by a payment service provider where a merchant may generate a payment flow during a checkout process, according to an embodiment. In FIG. 3E, another exemplary demo portal offered by a payment provider is shown where a merchant may make selections of payment flow options to generate a payment flow used during checkout with the merchant Thus, the demo portal shown in FIG. 3D includes exemplary but non-limiting payment flow options and information displayed to the merchant while utilizing the demo portal.

For example, FIG. 3E includes payment provider website 1118 for payment provider 1100. Similar to FIG. 3D, FIG. 3E shows the demo portal offered by payment provider 1100 through payment provider website 1118 using merchant's website 1120. Thus, merchant's website 1120 may integrate one or more of the payment flow options displayed in FIG. 3E. For example, payment provider tag 1122 may be integrated through selection of code/best practices tool 1108. Selection of code/best practices tool 1108 may display best practices text 1124, which informs the merchant of why the merchant should implement payment provider tag 1122 on a webpage or other displayable interface during a checkout process with the merchant. Thus, best practices test 1124 informs the merchant that use of payment provider tag 1122 may inform a user completing checkout on merchant's website 1120 that the merchant accepts payment provider 1100. Moreover, code/best practices tool 1108 may also display a code option 1108a to display code to implement payment provider tag 1122 on merchant's website 1120 or another interface (e.g., a dedicated application or mobile website for the user, which may be selected as the platform by the merchant).

FIG. 3F is an exemplary portal provided by a payment service provider where a merchant may generate a payment flow during a checkout process, according to an embodiment. In FIG. 3F, a third exemplary demo portal offered by a payment provider is shown where a merchant may make selections of payment flow options to generate a payment flow used during checkout with the merchant. In FIG. 3F, the merchant may customize the demo provided through the demo portal by selecting one or more payment flow options from a menus. Thus, the demo portal shown in FIG. 3D includes exemplary but non-limiting payment flow options and information displayed to the merchant while utilizing the demo portal.

In FIG. 3F, payment provider website 1118 for payment provider 1100 includes a menu of customizable options for payment flows. For example, the menu may provide one or more of the following selections for payment flow options. Such options may include a country 1126 for the merchant's checkout process, such as the United States. A language 1128 may also be offered for selection by the merchant, for example, English as shown in FIG. 3F. The merchant may also select from an integration 1130 that the merchant is interested in, such as API integrations for the payment flow. Payment provider 1100 may offer various product capabilities 1132, include types of checkout processes. Payment provider 1100 may also customize when a user is required to log in 1134 to payment provider 1100's service during checkout, for example, at checkout when processing a payment. The merchant may then select an apply button 1136 to commit the changes to the demo portal and view the payment flow options in a payment flow for merchant's website 1120 in the demo portal.

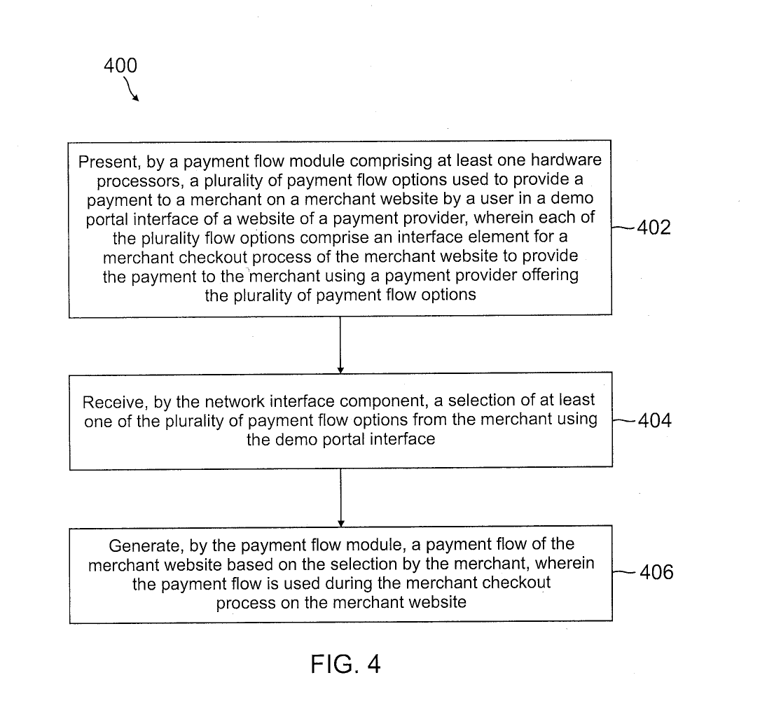

FIG. 4 is a flowchart of an exemplary process for selection of merchant and device specific payment flow, according to an embodiment. Note that one or more steps, processes, and methods described herein may be omitted, performed in a different sequence, or combined as desired or appropriate.

At step 402, a plurality of payment flow options used to provide a payment to a merchant on a merchant website by a user is presented in a demo portal of a website of a payment provider by a payment flow module comprising at least one hardware processor, wherein each of the plurality flow options comprise an interface element for a merchant checkout process of the merchant website to provide the payment to the merchant using a payment provider offering the plurality of payment flow options, and wherein the plurality of payment flow options are provided to a merchant device or server over a network using a network interface component for presentation to the merchant. The plurality of payment flow options may comprise a merchant category, a website login preference, a language, a region, a merchant logo, a merchant style, and a custom URL. Each of the plurality of payment flow options may be specific to a device platform used to access the merchant website.

At step 404, a selection of at least one of the plurality of payment flow options is received, via a network interface component, from the merchant using the demo portal. The selection may comprise an indication of each of the merchant category, the website login preference, the language, a region, the merchant logo, the merchant style, and the custom URL. The region of the plurality of payment flow options may be automatically selected by the payment flow module based on at least one of a top-level domain name used to access the website providing the demo portal, an IP address of the merchant, and merchant location information. The merchant category may also be automatically selected by the payment flow module using merchant information for the merchant accessed by the payment flow module, wherein the merchant information comprises a product type sold by the merchant, a regional presence of the merchant, revenue of the merchant, revenue streams of the merchant, and an amount of products sold by the merchant The selection may further comprise an indication of the device platform, wherein the payment flow module further presents the each of the plurality of payment flow options in a device platform interface matching the device platform through the demo portal.

At step 406, a payment flow for the merchant website is generated, by the payment flow module, based on the selection by the merchant, wherein the payment flow is used during the merchant checkout process on the merchant website. The network interface component may further receive a change to the indication of one of the payment flow options, wherein the payment flow module further generates a second payment flow for the merchant website using the selection and the change to the indication, and wherein the second payment flow is used during the merchant checkout process on the merchant website. The first payment flow may be generated based on the selection of the at least one of the plurality of payment flows specific to the device platform. The device platform may comprise one of a desktop, a mobile device, a tablet, and a dedicated application for the merchant website. The payment flow module may further access a navigation plane for the demo portal comprising each webpage or interface of the first payment flow, a presentation tool comprising an expandable pane having information for best practices associated with at least one of the plurality of payment flow options viewed by the merchant in the demo portal, a computer code presentation window comprising downloadable or viewable computer code associated with at least one of the plurality of payment flow options viewed by the merchant in the demo portal and/or a resources panel comprising resource to obtain information of at least one of the plurality of payment flow options viewed by the merchant in the demo portal, wherein the network interface component further communicates the aforementioned features to the merchant device or server.

Merchant information for the merchant may be received and used to generate a profile for the merchant using the selection, the payment flow, and the merchant information. A framework payment flow may be provided to at least one developer (e.g., merchant, coder, etc.) by the network interface component. Computer code for the framework payment flow from the at least one developer to create a specialized payment flow for at least one merchant may be received. Thus, at least one of the computer code and the specialized payment flow with the framework payment flow may be provided to at least one of another developer and another merchant through and open source portal. In various embodiments, a request to initiate a payment process experience using the payment flow may be received, and a demonstration of the payment flow using test information provided by the merchant may be provided to the merchant. The demonstration may comprise an exemplary payment process using the payment provider during the merchant checkout process.

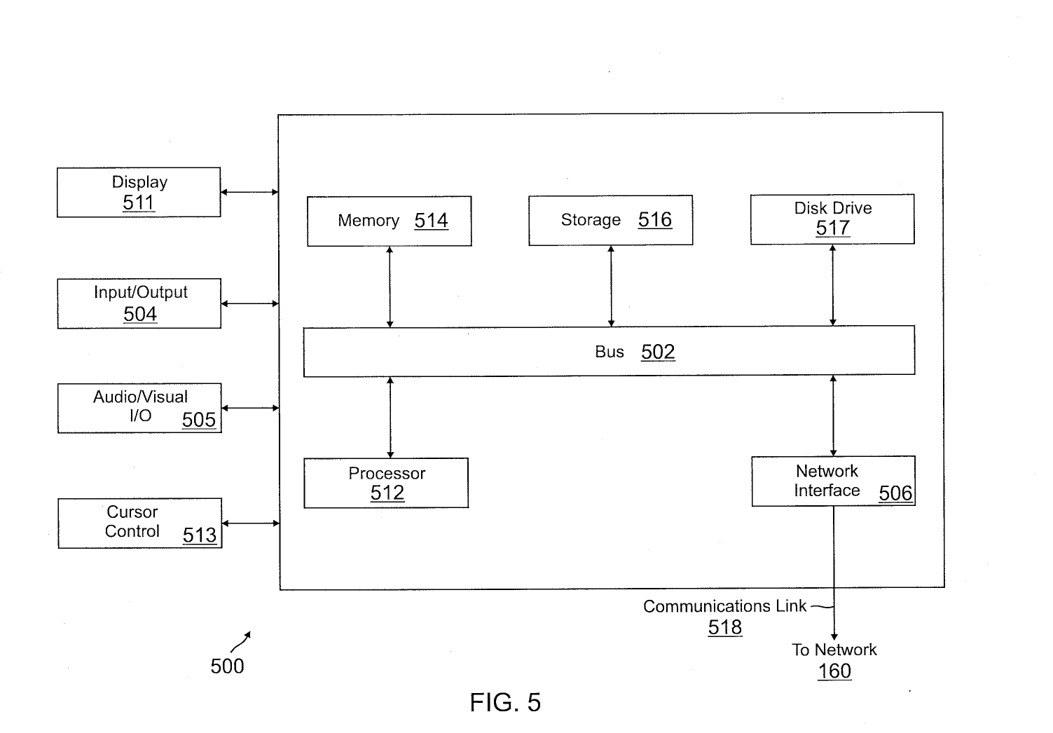

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant server, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a payment flow module comprising at least one hardware processors that accesses, a plurality of payment flow options presentable in a demo portal of a website of a payment provider and used to provide a payment to a merchant on a merchant website by a user, wherein each of the plurality flow options comprise an interface element for a merchant checkout process of the merchant website to provide the payment to the merchant using a payment provider offering the plurality of payment flow options, accesses a selection of at least one of the plurality of payment flow options from the merchant using the demo portal, and generates a first payment flow for the merchant website based on the selection by the merchant, wherein the first payment flow is used during the merchant checkout process on the merchant website;
a database stored to a non-transitory memory that stores the plurality of payment flow options, the selection and the first payment flow; and
a network interface component that provides the demo portal information having the plurality of payment flow options to a merchant device or server associated with the merchant, receives the selection from the merchant device or server, and communicates the first payment flow to the merchant through the merchant device or server.

2. The system of claim 1, wherein the plurality of payment flow options comprise at least one of a merchant category, a website login preference, a language, a region, a merchant logo, a merchant style, and a custom URL.

3. The system of claim 2, wherein the selection comprises an indication of each of the merchant category, the website login preference, the language, a region, the merchant logo, the merchant style, and the custom URL.

4. The system of claim 3, wherein the network interface component further receives a change to the indication, and wherein the payment flow module further generates a second payment flow for the merchant website using the selection and the change to the indication, wherein the second payment flow is used during the merchant checkout process on the merchant website.

5. The system of claim 2, wherein the region of the plurality of payment flow options is automatically selected by the payment flow module based on at least one of a top-level domain name used to access the website providing the demo portal, an IP address of the merchant, and merchant location information.

6. The system of claim 2, wherein the merchant category is automatically selected by the payment flow module using merchant information for the merchant accessed by the payment flow module, wherein the merchant information comprises a product type sold by the merchant, a regional presence of the merchant, revenue of the merchant, revenue streams of the merchant, and an amount of products sold by the merchant.

7. The system of claim 1, wherein each of the plurality of payment flow options is specific to a device platform used to access the merchant website.

8. The system of claim 7, wherein the selection further comprises an indication of the device platform, and wherein the payment flow module further presents the each of the plurality of payment flow options in a device platform interface matching the device platform through the demo portal.

9. The system of claim 8, wherein the first payment flow is generated based on the selection of the at least one of the plurality of payment flow options specific to the device platform.

10. The system of claim 7, wherein the device platform comprises one of a desktop, a mobile device, a tablet, and a dedicated application for the merchant website.

11. The system of claim 1, wherein the payment flow module further accesses a navigation plane for the demo portal comprising each webpage or interface of the first payment flow, and wherein the network interface component further communicates the navigation plane to the merchant device or server.

12. The system of claim 1, wherein the payment flow module further accesses a presentation tool comprising an expandable pane having information for best practices associated with at least one of the plurality of payment flow options viewed by the merchant in the demo portal, and wherein the network interface component further communicates the presentation tool to the merchant device or server.

13. The system of claim 1, wherein the payment flow module further accesses a computer code presentation window comprising downloadable or viewable computer code associated with at least one of the plurality of payment flow options viewed by the merchant in the demo portal, and wherein the network interface component further communicates the computer code presentation window to the merchant device or server.

14. The system of claim 1, wherein the payment flow module further accesses a resources panel comprising resource to obtain information of at least one of the plurality of payment flow options viewed by the merchant in the demo portal, and wherein the network interface component further communicates the resources panel to the merchant device or server.

15. A method comprising:
presenting, by a payment flow module comprising at least one hardware processors, a plurality of payment flow options used to provide a payment to a merchant on a merchant website by a user in a demo portal of a website of a payment provider, wherein each of the plurality flow options comprise an interface element for a merchant checkout process of the merchant website to provide the payment to the merchant using a payment provider offering the plurality of payment flow options, and wherein the plurality of payment flow options are provided to a merchant device or server over a network using a network interface component for presentation to the merchant;
receiving, via the network interface component, a selection of at least one of the plurality of payment flow options from the merchant using the demo portal; and
generating, by the payment flow module, a payment flow for the merchant website based on the selection by the merchant, wherein the payment flow is used during the merchant checkout process on the merchant website.

16. The method of claim 15, further comprising:
receiving, via the network interface component, merchant information for the merchant; and
generating, by the payment flow module, a profile for the merchant using the selection, the payment flow, and the merchant information.

17. The method of claim 16, further comprising:
proving, via the network interface component, a framework payment flow to at least one developer;
receiving, via the network interface component, computer code for the framework payment flow from the at least one developer to create a specialized payment flow for at least one merchant; and
providing, by the payment flow module, at least one of the computer code and the specialized payment flow with the framework payment flow to at least one of another developer and another merchant through and open source portal.

18. The method of claim 15, further comprising:
receiving, via the network interface component, a request to initiate a payment process experience using the payment flow; and
providing, by the payment flow, a demonstration of the payment flow using test information provided by the merchant.

19. The method of claim 18, wherein the demonstration comprises an exemplary payment process using the payment provider during the merchant checkout process.

20. A non-transitory computer-readable medium comprising executable modules which, in response to execution by a computer system, cause the computer system to perform a method comprising:
presenting, by a payment flow module comprising at least one hardware processors, a plurality of payment flow options used to provide a payment to a merchant on a merchant website by a user in a demo portal of a website of a payment provider, wherein each of the plurality flow options comprise an interface element for a merchant checkout process of the merchant website to provide the payment to the merchant using a payment provider offering the plurality of payment flow options, and wherein the plurality of payment flow options are provided to a merchant device or server over a network using a network interface component for presentation to the merchant;
receiving, via the network interface component, a selection of at least one of the plurality of payment flow options from the merchant using the demo portal; and
generating, by the payment flow module, a payment flow for the merchant website based on the selection by the merchant, wherein the payment flow is used during the merchant checkout process on the merchant website.
